(19) United States
(12) Patent Application Publication
(10) Pub. No.: US 2014/0222223 A1
(43) Pub. Date: Aug. 7, 2014

(54) WEB-BASED IRRIGATION CONTROLLER

(71) Applicants: Jaycen Horton, Phoenix, AZ (US); Arthur Steingart, Phoenix, AZ (US); Howard Cohen, Phoenix, AZ (US); Bryce Schotz, Phoenix, AZ (US)

(72) Inventors: Jaycen Horton, Phoenix, AZ (US); Arthur Steingart, Phoenix, AZ (US); Howard Cohen, Phoenix, AZ (US); Bryce Schotz, Phoenix, AZ (US)

(21) Appl. No.: 14/107,702

(22) Filed: Dec. 16, 2013

Related U.S. Application Data
(60) Provisional application No. 61/737,507, filed on Dec. 14, 2012.

(51) Int. Cl. G05D 7/06

(52) U.S. Cl. CPC G05D 7/0617
USPC 700/284

(57) ABSTRACT

A web-based irrigation controller with application server can avoid need for access points for irrigation controller communications to the application server, need for configurations on any number of any type of web-based appliances to communicate to the application server, and can provide easy access to giant databases of weather and plant growing information, automatic control and simplification for the plant and lawn growing effort, easy access to reports of actual water usage and power usage and maintenance problems, using sprinklers in an unusual manner to scare away birds from a freshly seeded lawn, reducing lawn water usage for unskilled users by backing off lawn timings until the user intervenes, slow seasonal adjustment to watering times without need for application server intervention, life-cycle based watering schedules based on types of garden plantings and easy for the user to follow the actions of a local amateur master gardener in growing similar plants.

### CROSS-REFERENCE TO RELATED APPLICATION

The present application is related to and claims the benefit and priority of U.S. Provisional Patent Application No. 61/737,507, filed Dec. 14, 2013, the entirety of which is hereby incorporated herein by reference.

### BACKGROUND

This invention relates to the field of irrigation controllers. More specifically, the invention replaces conventional irrigation controllers with a much easier to use internet-connected technology with improved accuracy that can lead to more efficient water usage. The irrigation controller can access the web-based application server without need of an access point. The irrigation controller and application server can communicate over a bi-directional communications network with or without user intervention. The user can communicate with the application server with any number or any type of web-based appliance without the need for software downloads or any kind of configuration of the web-based appliance.

As an alternate implementation for users without web-access, the user can control and interact with the irrigation controller over an ad-hoc bi-directional communications network. The user here has full control over the irrigation timer using information he gathers manually or his best judgment.

There are many known devices to time and control irrigation. A user of conventional timers would on occasion manually set the timer/controller to turn on water for specified start times and durations. The manual settings are usually done by button pushes, slide switches and dials; all mechanical adjustments taking place at the timer/controller itself. Sometimes additional devices such as rain gauges, humidity sensors and temperature sensors are connected to the timer/controller to allow adjustments to the start times or durations based on local weather conditions. However rain gauges require a lot of maintenance and placement of other gauges is strongly influenced by direct sunlight. Further, not many irrigation systems account for wind, which leads to much more evaporation.

Symple Technology LLC will run the application server dedicated to data-mining location-specific weather and plant data, and processing the resultant data. A user can access the application server, which will allow him/her to log in, set up yard sections watered by enabling enumerated solenoids, enter lawn types, soil types, soil topology, amount of shade, specific plant types, and other user-specific data. This is known as the “set up procedure”, and results in a user-specific download to his irrigation controller. A user can choose to just enter his own timings from a menu that ensures his timings can be done—and calculates a rough estimate of water consumption and costs. Or a user can select from menus based on his/her user-specific data then watering times and durations (called the “baseline schedule”) are automatically selected.

Nowadays, many websites track the rain-fall, temperature, wind and humidity for every postal zipcode or other location coordinates. This information is taken constantly. A given user in a particular zipcode may discover that he needs a little more or less than is recommended for his zipcode—but that variance should be very consistent, and he can scale the web data for his needs. The application server will also gather agronomy information on the specific water needs of a variety of popular plants and grasses and make it available to users. Many users will prefer to automatically set up their user-specific timings based on this plant and grasses database. And of course, the user is free to make adjustments to these initial timings. Additionally, the web-based information should predict his/her lawn watering needs over the progression of seasons. It should predict the life span of his legume garden so the watering stops automatically after the garden has played out. Seasonal or garden longevity information can be programmed into the baseline schedule download, and without further communications from the user, the duration times are scaled as the seasons progress.

Post-set-up, the application server will access the local weather conditions to modify the baseline schedule. For example if a quarter inch of rain has occurred or is predicted to occur, then adjustments are sent to the irrigation controller for just that day. Or if a garden plant has life-cycle watering needs, these are downloaded to the irrigation on a daily basis. The application server modifications to the baseline schedule occur in the background and do not need to involve the user.

Another modernization of our irrigation controller will be to provide feedback as to the measured waterflow during irrigation times and even when the irrigation times are off. A flow meter can be put into the feeder water pipe upstream of all the sprinkler solenoids. Such a meter can, for instance, be an impeller in a short length of pipe that can magnetically pickup the spin rate and report back to the timer/controller.

The irrigation controller can send data to the application server to keep log records of duration times for each water channel, and flow rates as well. The application server can then contact the user with messages about possible problems with the irrigation system. For example, too much flow rate (broken sprinkler head), no flow rate (stuck sprinkler solenoid) or small water flow when the water channel is not on (slow, continuous water leak somewhere between flow meter and solenoids.)

The irrigation controller has several methods enabling users to start lawns, conserve water on mature lawns, shrubbery and trees, and start a garden without deep “green thumb” knowledge learned from experience. Through the application server, a new gardener can follow a local amateur master gardener and copy his/her actions on an similar group of plantings.

### BRIEF SUMMARY OF THE INVENTION

The key component is the Symple hosted application server to create and store a user's irrigation information and interface to his/her irrigation controller. The irrigation controller is usually mounted on a garage wall, with all the sprinkler solenoid wires attached to it, usually two wires per sprinkler solenoid. The irrigation controller is wirelessly added to a user's home WiFi infrastructure bi-directional communications network. In the event he/she does not have a home network, the user can go to an ad-hoc, point-to-point WiFi communications link. Using any number or any kind of web-enabled appliances communicating with the application server, the user can input his irrigation map, set up his irrigation start times and durations, and get his user-specific baseline schedule checked and downloaded to his/her irrigation controller. Or, the user can use a simpler and more sophisticated method of automatically assigning waterings based on his/her geographic location and types of plants and grasses. Any web-enabled appliance: PC laptop, mac, iPhone, iPad, Droid, or various smart-phone types, connected to the application server can be used to interact with his/her irrigation controller—without the need for downloading any app or software. Downloadable apps or software can be made available for users who don't wish to have their information stored on the cloud (specifically on our application server). Further, if the user does not have a home network, using an ad-hoc network the user can download settings into his/her irrigation controller using an app or software on his/her web-enabled appliance. This can be a little more complicated by the fact that there are some web-enabled appliances such as Droids that need a special app to deal with ad-hoc networks.

Since our irrigation controller is controlled from the application server, there is no need for any mechanical input for setting water channel start times or duration times. The interface is strictly at the web-enabled appliance, and the user can set up the irrigation controller via the application server from any location in his house that receives his local, wireless WiFi network. A small LCD readout is located on the irrigation controller to assure the user as to the irrigation controller status and help with software upgrades. An antenna can be placed on the irrigation controller that can allow home network access from over 1,000 feet away. The application server is protected by industry-standard security measures.

The application server can message the irrigation controller many times a day with modifications due to local weather conditions or plant life-cycle needs. But the irrigation controller can make its own daily adjustments to compensate for the progression of the seasons. A lawn needs more watering in July than in September, and those seasonal adjustments are based on historical data that can be downloaded to the irrigation controller as part of the baseline schedule.

In addition to interacting with all the users and all the irrigation controllers, the application server scours the internet for local weather data and can send messages to the irrigations controllers for adjusting the baseline schedule for any given day. The algorithms on the application server that do this will be continually updated in a way transparent to the user. Additionally, while we reserve the right to charge a small user fee for this application server access, it is expected that advertising on the site will pay the application server maintenance and product improvement expenses.

Further, it is expected that several local amateur master gardeners will volunteer to comment on watering choices for their locale or suggest when to plant, fertilize and tend to certain types of plants—making our application server almost a social media for gardeners. The application server can also present the user with a log of his actual water usage for his system, expressed in gallons or dollars. This should greatly help with his conservation efforts. After running his system for several years, even a fairly disinterested user should be able to minimize his water usage to achieve the overall yard or garden result he wants. The best optimizations should occur if a user chooses daily or even hourly updates from the application server for duration timings, adjusting or even skipping or advancing watering for a day. Finally, the user will be notified as to possible failures in his watering channels as determined by electrical sensing (ie solenoid is connected to 24Vac, but does not draw current) or flow metering. Flow metering will inform the user of possible broken sprinkler head (too much water flow), failed solenoid (no water flow) or slow continuous leaks (small water flow even when everything is off).

Another innovation is the ability to water up to 8 times per day, which is useful when starting new lawns from seeds. There is a special 9^{th} timing that we call “bird scare mode” or “burst mode.” Newly seeded lawns are attractive to flocks of birds that land on the newly seeded area and spend hours at a time poking through the dirt picking out the un-sprouted seeds. Our idea is to turn each water channel on briefly to reduce the birds' comfort zone, then wait a short while and repeat. As an example, you could water for 15 seconds, wait 3 minutes and do it repeatedly from early morning to mid-afternoon. During, say 8 hours, there is a total watering time of only 40 minutes. So in addition to supplying the heavy watering need of a newly seeded lawn, we are meting it out in a way to make it uncomfortable for grazing birds. If the newly seeded lawn is big enough to have several watering channels, then we can cycle from one watering channel to the next each with its own on-time and delay interval. Newer sprinkler heads conserve more water by shooting larger water droplets at lower angles. It is our belief that this will aid in making bird flocks more uncomfortable.

The irrigation controller and our application server do several new things for the irrigation user, and does it in a manner as simple and automated as possible while allowing the user to get involved more deeply if he/she wishes. It makes reseeding a lawn much easier. It makes the irrigation controller accessible from anywhere in the house using his/her preferred web-enabled appliance. It enhances the user's sense of control by getting hard numbers back on water consumption and allows water usage to be minimized at each of his/her various irrigation projects on the user's property. It automatically detects certain faults that can occur in the user's irrigation system. It allows him/her to choose on watering and planting times recommended by master gardeners in the user's own locale—gaining an instant “green thumb” if you will. It is a system that automatically scales watering as the growing season advances and recedes. A user can be a casual user, making adjustments every few months or even years, or he/she can be an aggressive user that can use watering to its upmost effectiveness. In short, it empowers the user to take the reins of a system that is often mysterious and neglected.

### BRIEF DESCRIPTION OF THE DRAWINGS

Important Note: In these drawings, we refer to the “irrigation controller” as a WBST (for web-based sprinkler timer). We refer to the “application server” as the Symple server or just the server.

FIG. 1. Example Flowchart of WBST Timer/Controller Program

FIG. 2. Pictorial of WBST Web-Site Data Gathering and Cloud Data Storage

FIG. 3. Message Protocol: The Linkage Between the WBST Timer/Controller Unit and the Symple Technology LLC Server

FIG. 4. Ad-Hoc (Point-to-Point) Usage with Apps or Custom Software, No Web-Site, and Local Data Storage

FIG. 5. WBST Timer/Controller Hardware Internals

FIG. 6. Loopback Board for Returning to Old Timer/Controller

FIG. 7. WBST Timer/Controller Flowcheck Unit Block Diagram

FIG. 8. WBST Timer/Controller Example Installation #1

FIG. 8A. WBST Timer/Controller Data Set up for Installation #1

FIG. 8B. WBST Timer/Controller Seasonal Data for Installation #1

FIG. 9. WBST Timer/Controller Example Installation #2

FIG. 9A. WBST Timer/Controller Data Set up for Installation #2

FIG. 10. WBST Timer/Controller Example Installation #3

FIG. 10A. WBST Timer/Controller Data Set up for Installation #3

FIG. 11. WBST Timer/Controller Example Installation #4

FIG. 11A. WBST Timer/Controller Data Set up for Installation #4

FIG. 12. WBST Timer/Controller Example Installation #5

FIG. 12A. WBST Timer/Controller Data Set up for Installation #5

FIG. 13. illustrates systems according to certain embodiments of the present invention.

FIG. 14. illustrates a method according to certain embodiments of the present invention.

### DETAILED DESCRIPTION

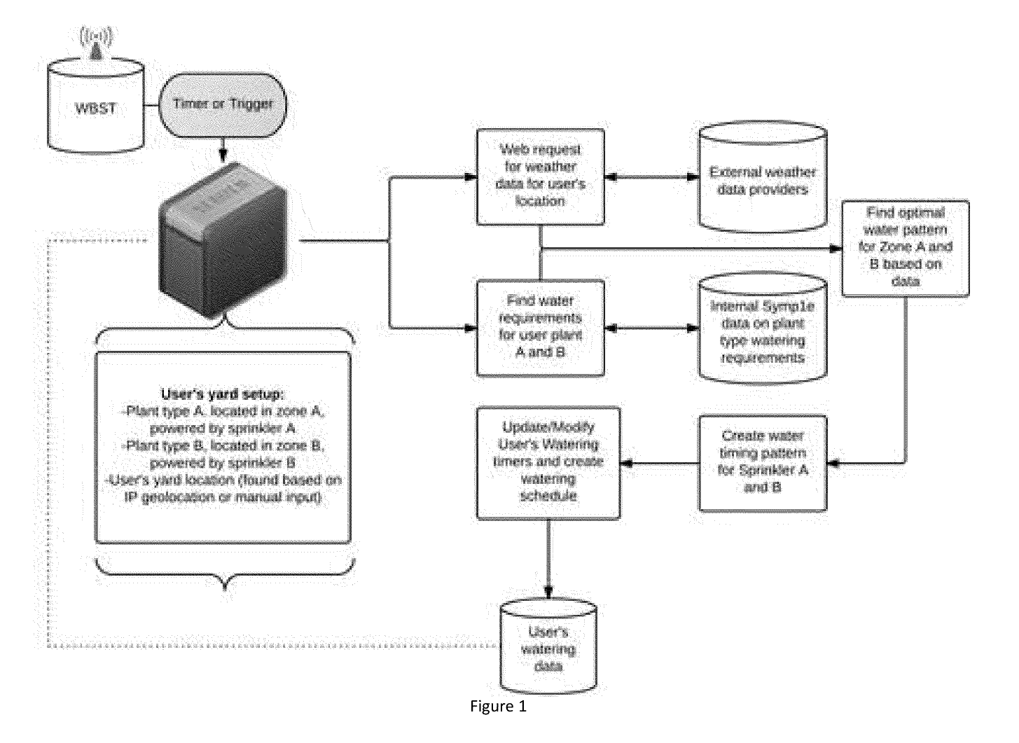

FIG. 1. Example Flowchart of WBST Timer/Controller Program

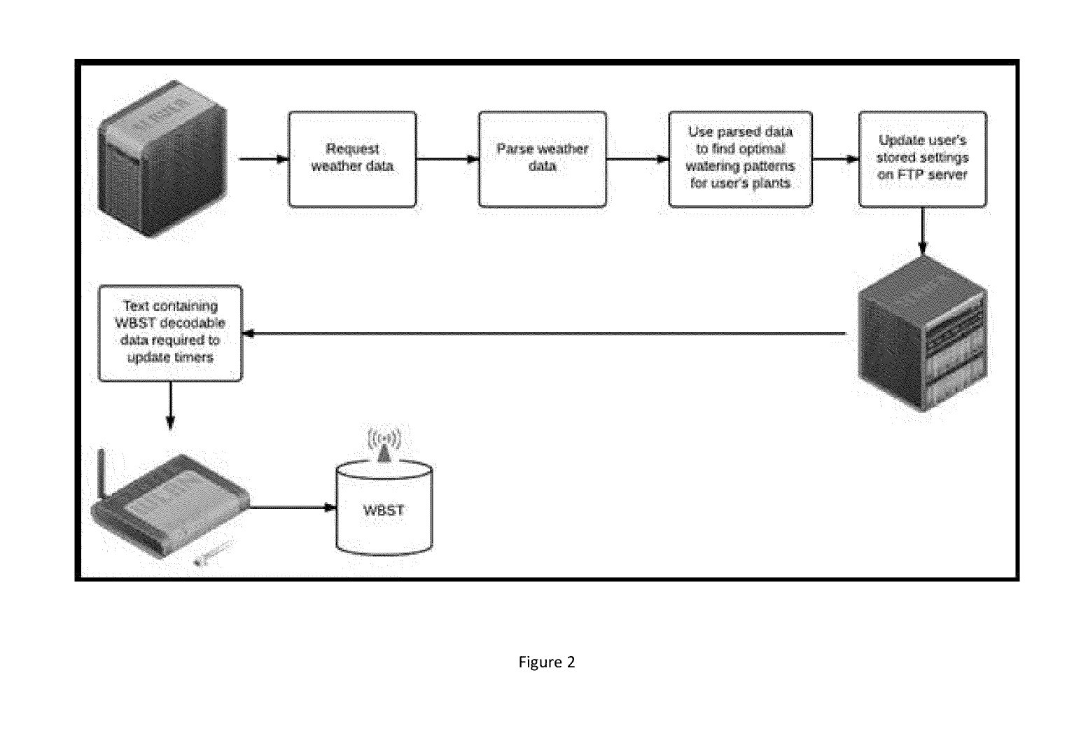

FIG. 2. Pictorial of WBST Web-Site Data Gathering and Cloud Data Storage

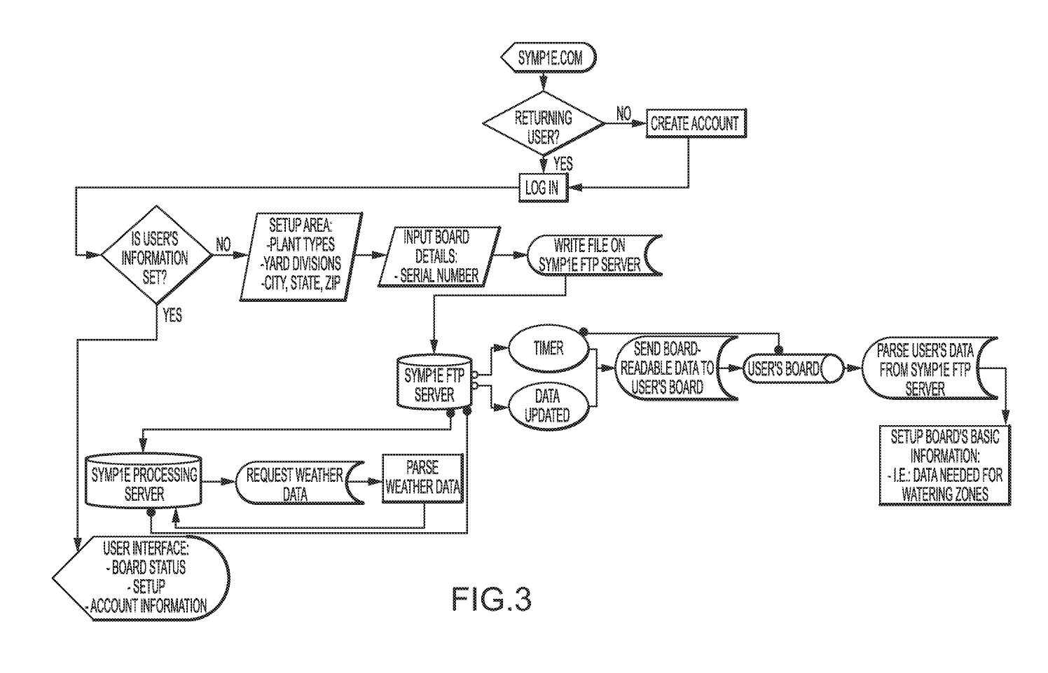

FIG. 3. Message Protocol: The Linkage Between the WBST Timer/Controller Unit and the Symple Technology LLC Server

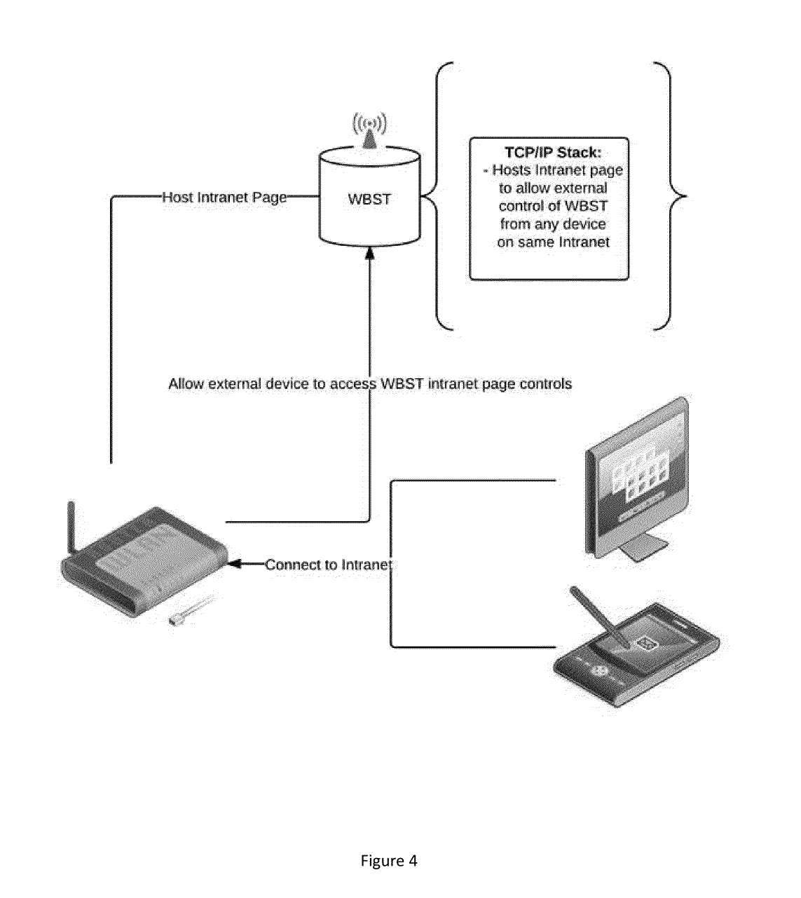

FIG. 4. Ad-Hoc (Point-to-Point) Usage with Apps or Custom Software, No Web-Site, and Local Data Storage

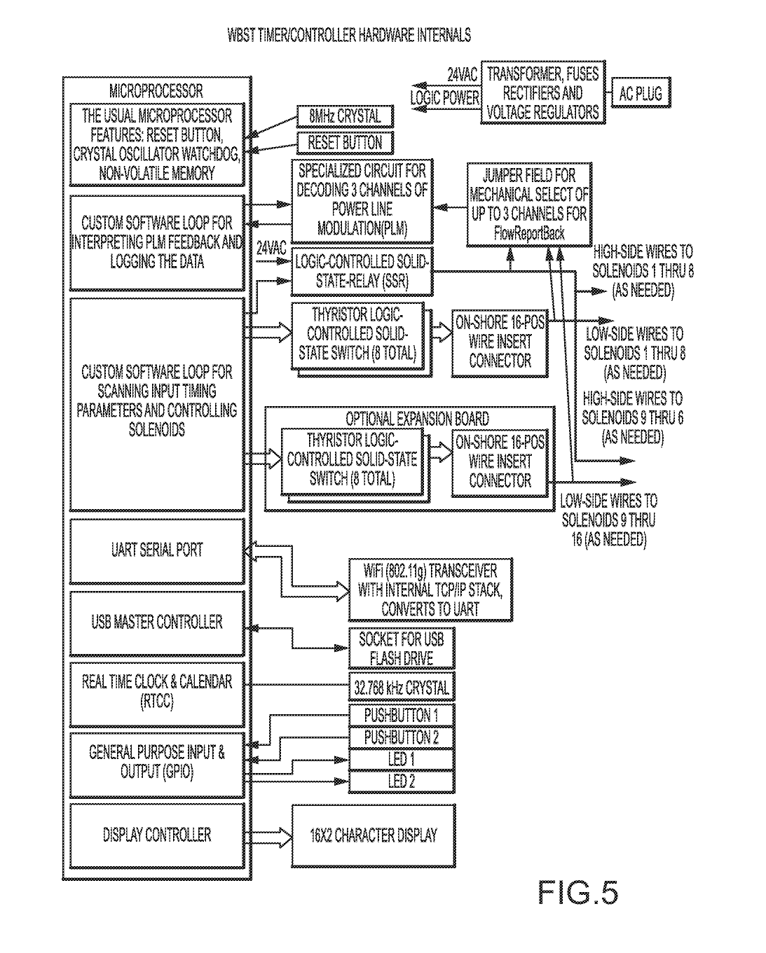

FIG. 5. WBST Timer/Controller Hardware Internals

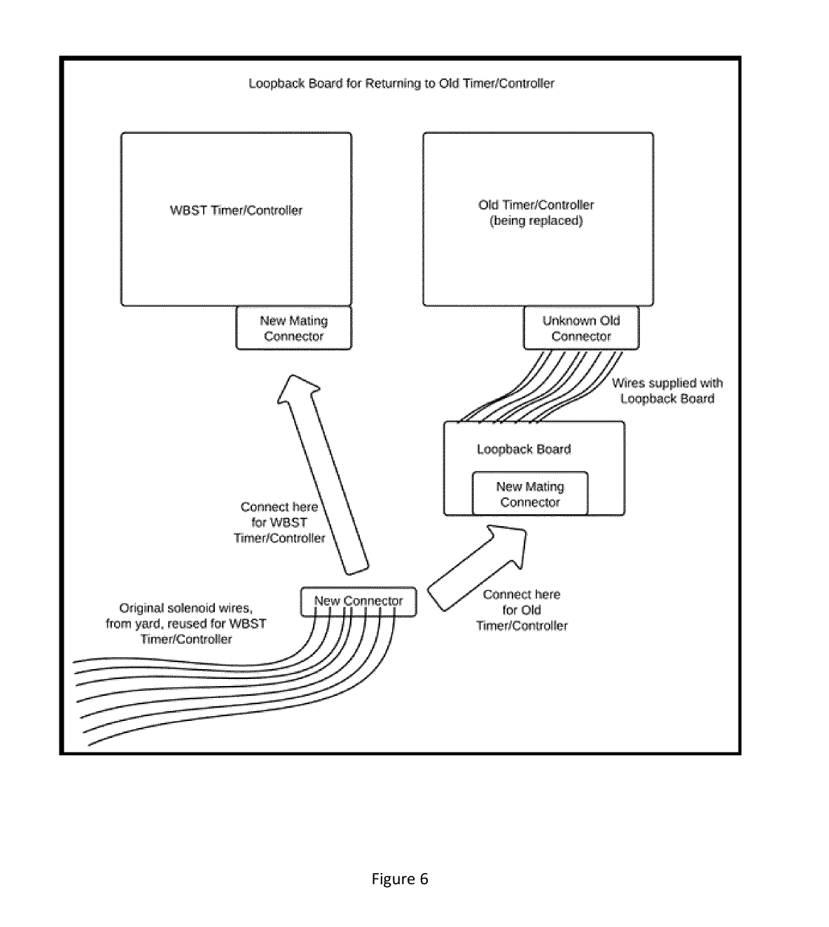

FIG. 6. Loopback Board for Returning to Old Timer/Controller

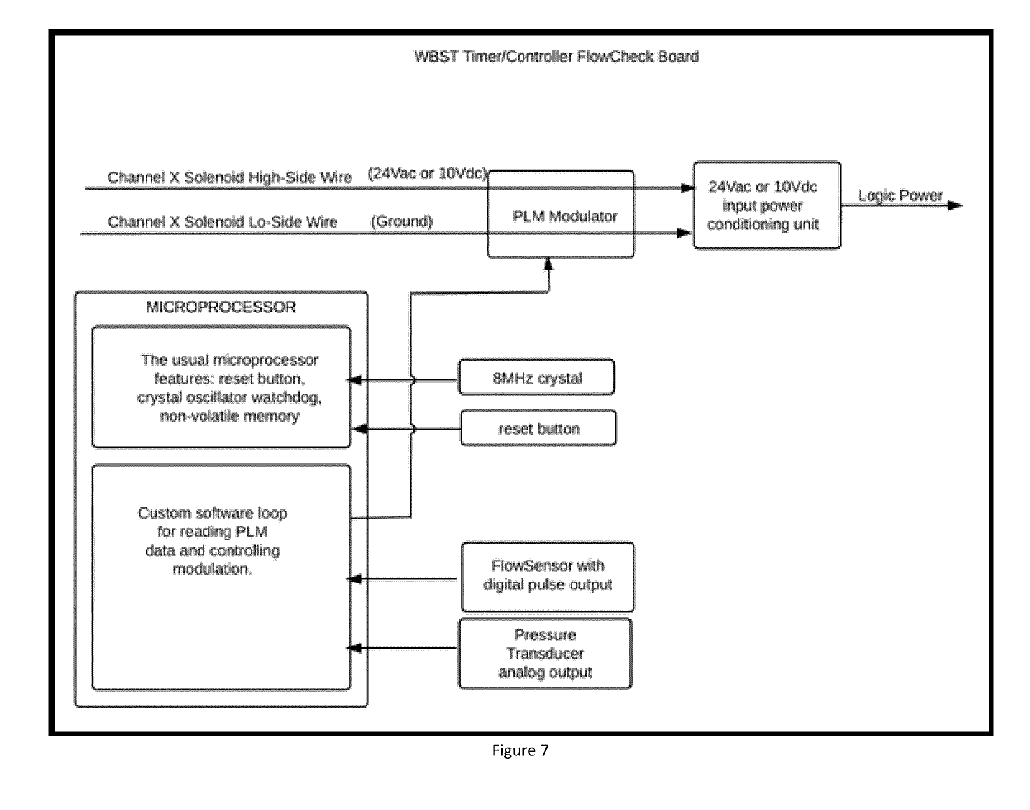

FIG. 7. WBST Timer/Controller Flowcheck Unit Block Diagram

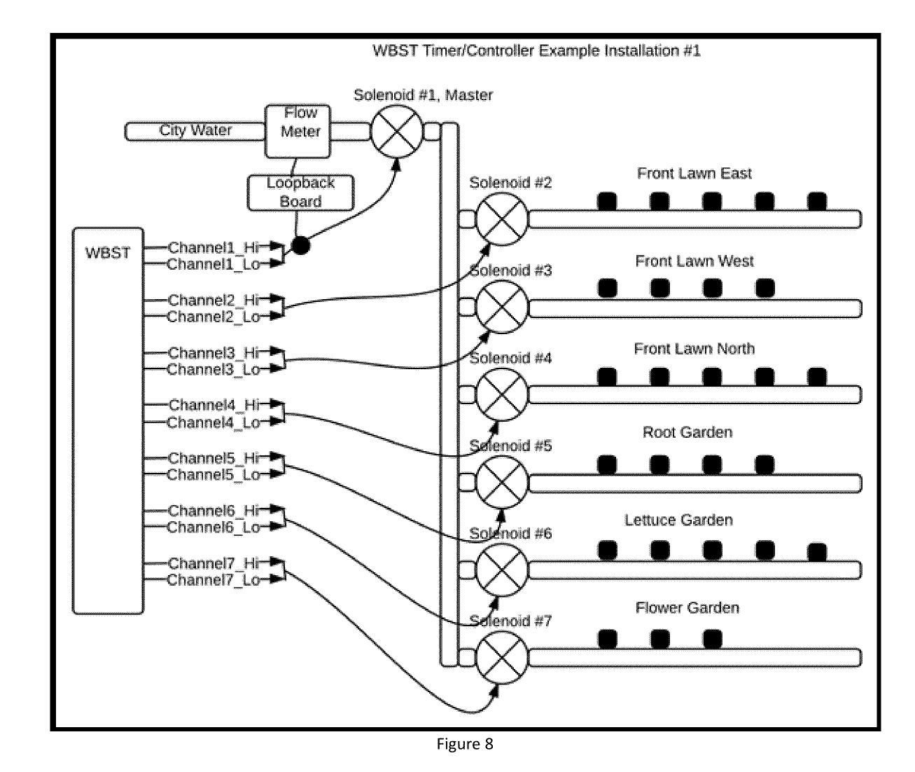

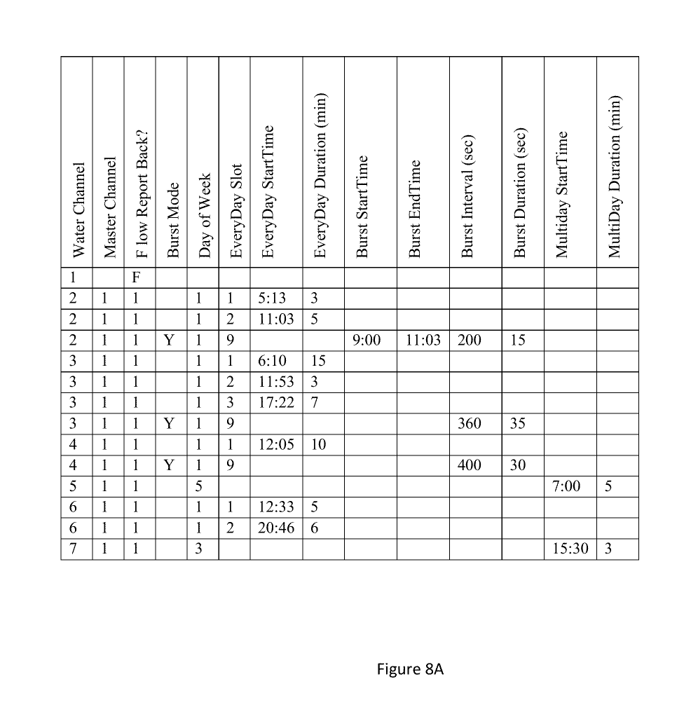

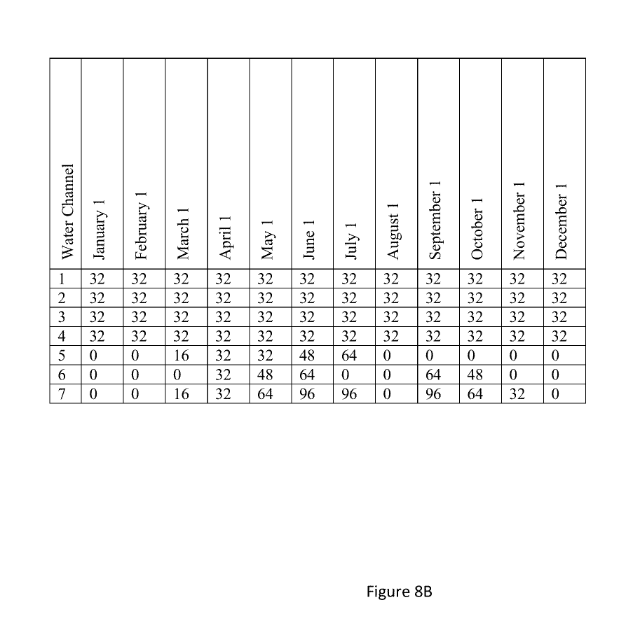

FIG. 8. WBST Timer/Controller Example Installation #1

FIG. 8A. WBST Timer/Controller Data Set up for Installation #1

Detailed Discussion of Example Installation #1:

This installation has a Master solenoid, which means that all waterings are double-gated. There really is no reason to double-gate, but some people are nervous about having water come on with just one control. Our software just looks at the timings of all the slaves and makes sure that this master is on at those times. So the WBST needs to be informed of any solenoid that has a master.

The WBST needs to be informed of which, if any, solenoid is monitored by a flow meter (interacting with our Loopback Board). Also the WBST needs to know which channel has the flow meter information encoded on it. This is marked by an “F”. There can be up to 8 timings for an EveryDay channel. Those timings are marked 1 through 8, the StartTimes can be in sorted order. For simplicity, the EveryDay Durations are shown in whole minutes.

An Everyday channel can also have a 9th timing, called Burst Timing. The lowest Burst channel has the StartTime and EndTime that controls the burst. BurstInteval and BurstDuration are shown in seconds, as they are expected to be short times.

Multiday channels can have only one timing. That timing is repeated every 2, 3, 4, 5, 6 or 7 days. Or the timing can be done every Sunday (8), Monday (9), . . . Saturday (14).

In Example Installation #1, Channel 1 is a master solenoid, with channels 2 through 7 governed by it. Channel #2 is called the “Front Lawn East.” Every day there is a 3-minute watering starting at 5:13 AM. Also, every day there is a Burst watering which starts at 9:00 AM and ends at 11:03 AM. In the Burst, Channel #2 goes for 15 seconds, then after a 6-minute wait Channel #3 goes for 35 seconds, then after a 6.67 minute wait Channel #4 goes for 30 seconds. Then there is a wait of 3.33 minutes and Channel #2 goes again for 15 seconds. So the cycle takes 1040 seconds, or 17.33 minutes. A little over 7 cycles of this occur between 9:00 AM and 11:03 AM.

Channel #2 also does a 5-minute watering immediately after the burst ends at 11:03 AM.

Channel #3 is called the “Front Yard West.” Everyday there is a 15-minute watering starting at 6:10 AM. The Channel #3 participates in the burst watering described above. After that, there is a 3-minute watering at 11:53 AM and a 7-minute watering at 5:22 PM.

Channel #4 is called the “Front Yard North.” Everyday there is a 10-minute watering starting at 12:05 PM. Earlier than that Channel #4 participates in the burst watering described above.

Channel #5 is called the “Root Garden.” Every five days there is a 5-minute watering starting at 7:00 AM.

Channel #6 is called the “Lettuce Garden.” It gets watered twice a day at 12:33 PM (5 minutes) and 8:46 PM (6-minutes).

Channel #7 is called the “Flower Garden.” Every five days there is a 3-minute watering starting at 3:30 PM.

FIG. 8B. WBST Timer/Controller Seasonal Data for Installation #1

There is a useful control that allows the watering durations to be adjusted as the seasons change. Assuming the WBST has its timings initially entered in early April. The Code 32 indicated the Scale Factor for water durations is 1.00 times norminal (The math is just ScaleFactor/32). As the summer heats up, more watering is needed. For example on May 23^{th} Channel #7, the “Flower Garden” will get ((23+2)*96+(30−23)*64)/32/32=2.781 times nominal watering. So on that day it gets a 3 minutes*2.781=8.34 minute watering. (NOTE: The 2 in the calculation for May 23^{rd} is just to roughly adjust May into having 32 days instead of just 30. It is of minor consequence.)

The Scale Factor goes from 0 to 99, here are a few examples:

| | |
|---|---|
| 64 is 2.00 times normal watering | 96 is 3.00 times normal watering |
| 99 is 3.09 times normal watering | 16 is 0.50 times normal watering |
| 11 is 0.34 times normal watering | 8 is 0.25 times normal watering |
| 1 is 0.03 times normal watering | 0 is 0 times normal watering |

For channels using burst modes, no scaling at all is done, for any of the EveryDay timings, not just burst. It is expected that burst is used temporarily on newly seeded lawns. The timings will be all adjusted to get rid of the burst mode—once the lawn is established.

Some of the timings go to zero. In northern climes irrigation pipes are cleared of water so they won't crack when it freezes. In southern climes the Bermuda grass is dormant. Alternatively, winter rye grass lawns can need more water than summer Bermuda grass lawns. Also, gardens can be set up go to zero water in the late summer when the garden has played out, in case the owner forgets to adjust water timings.

The seasonal adjustments are used in addition to possibly daily updates to reduce/increase water timings due to rain or unexpected drought. The daily updates can done either to adjust watering durations, or skip or advance days. Seasonal adjustments are done by only adjusting water durations based on daily calculation of the ScaleFactors.

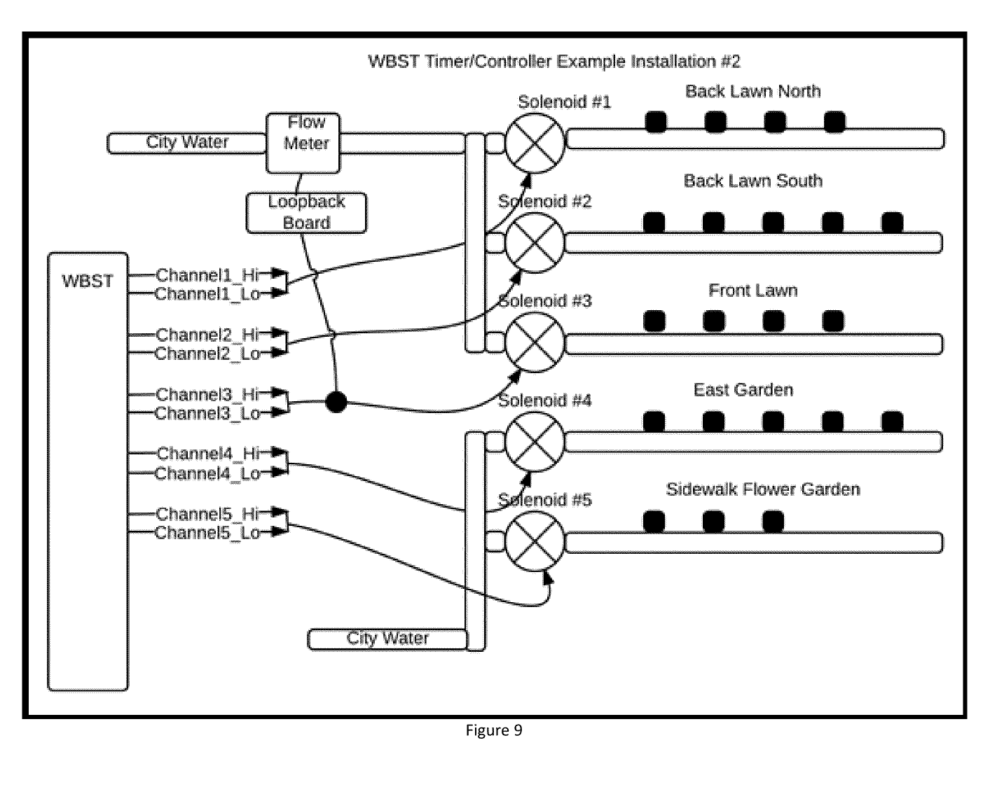

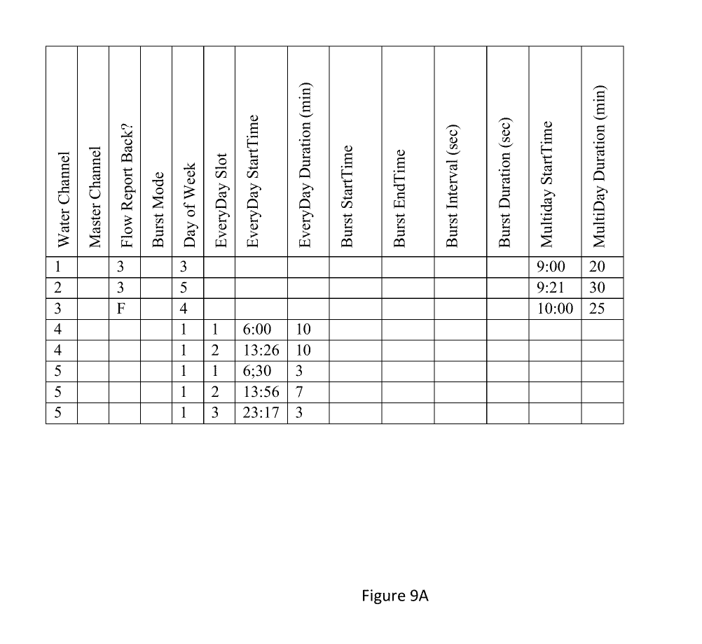

FIG. 9. WBST Timer/Controller Example Installation #2

FIG. 9A. WBST Timer/Controller Data Set up for Installation #2

For a more detailed explanation, refer to the discussion after FIG. 8A, as that discussion generally applies here.

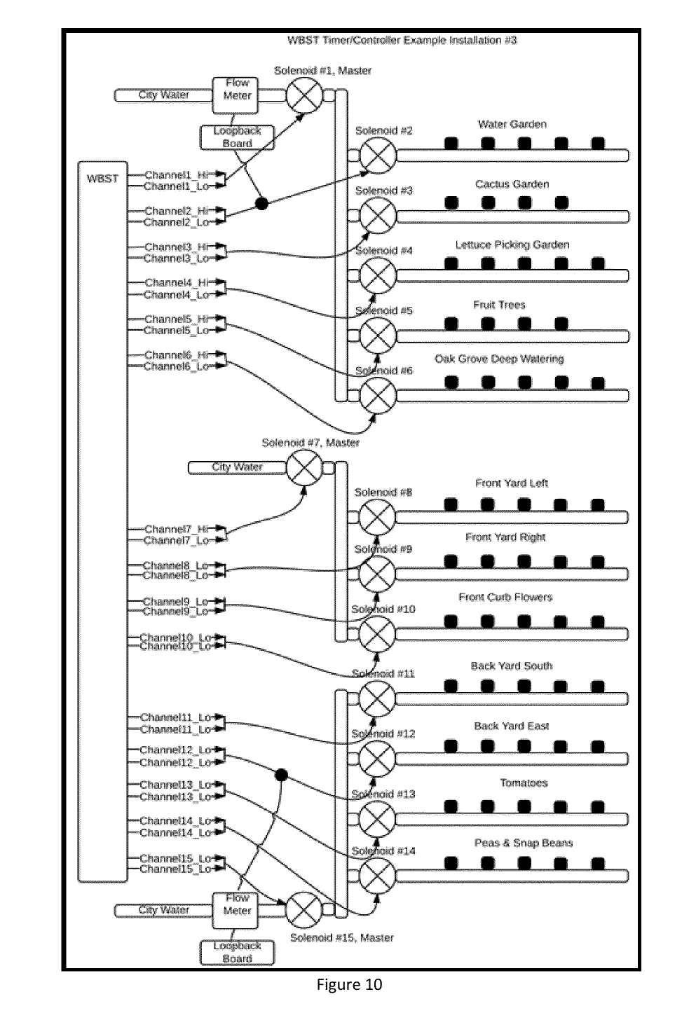

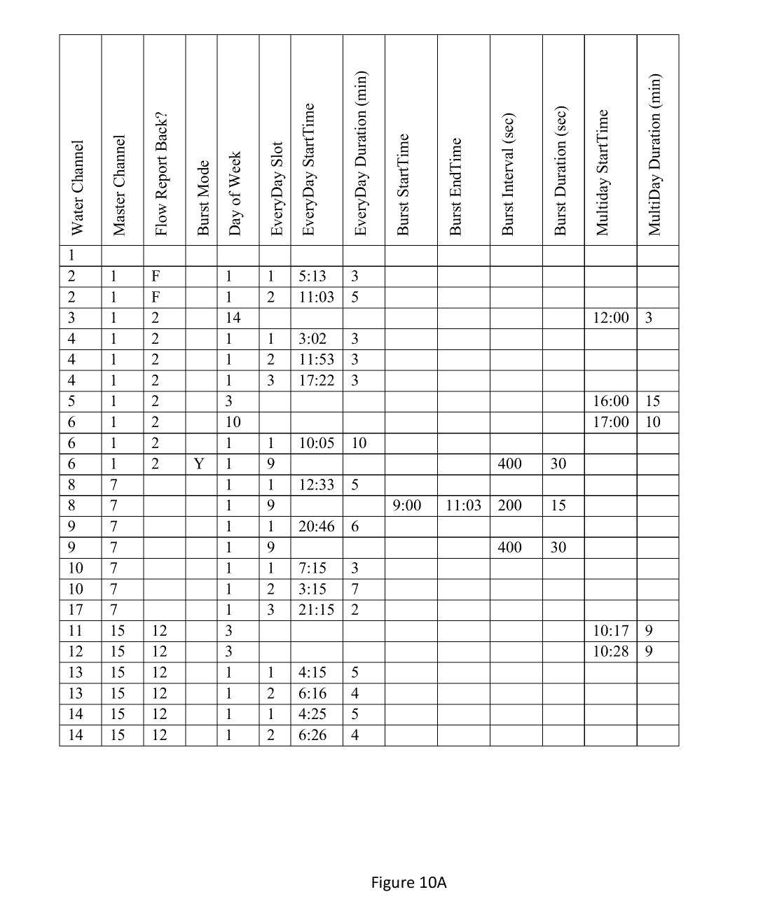

FIG. 10. WBST Timer/Controller Example Installation #3

FIG. 10A. WBST Timer/Controller Data Set up for Installation #3

For a more detailed explanation, refer to the discussion after FIG. 8A, as that discussion generally applies here.

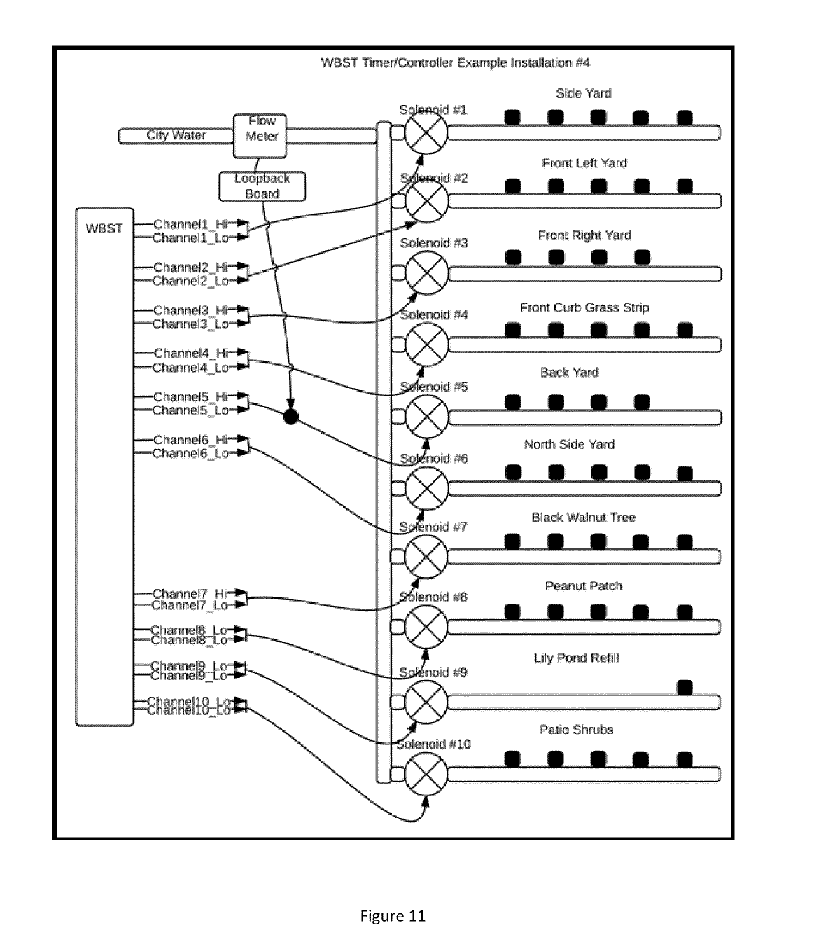

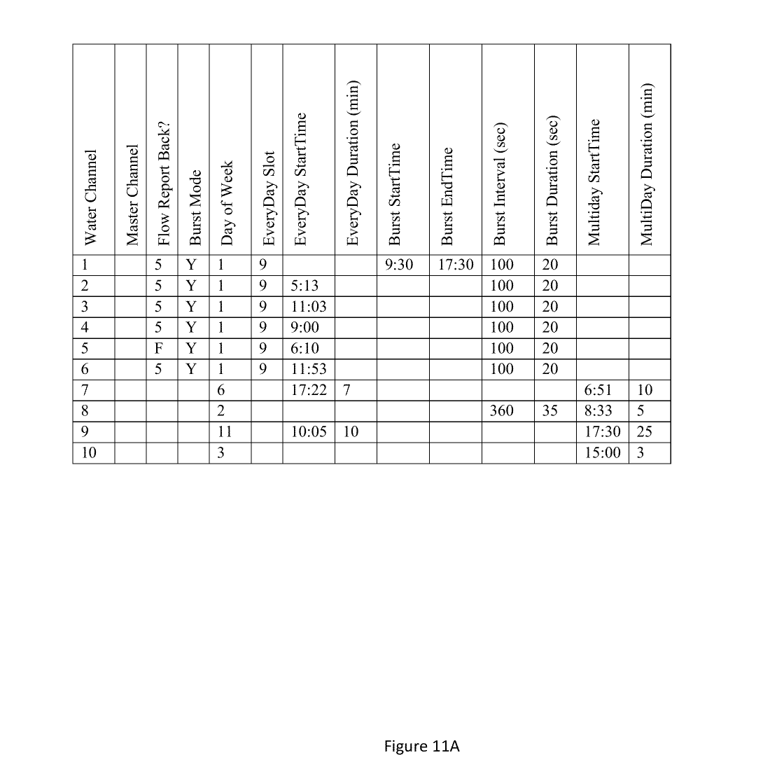

FIG. 11. WBST Timer/Controller Example Installation #4

FIG. 11A. WBST Timer/Controller Data Set up for Installation #4

For a more detailed explanation, refer to the discussion after FIG. 8A, as that discussion generally applies here.

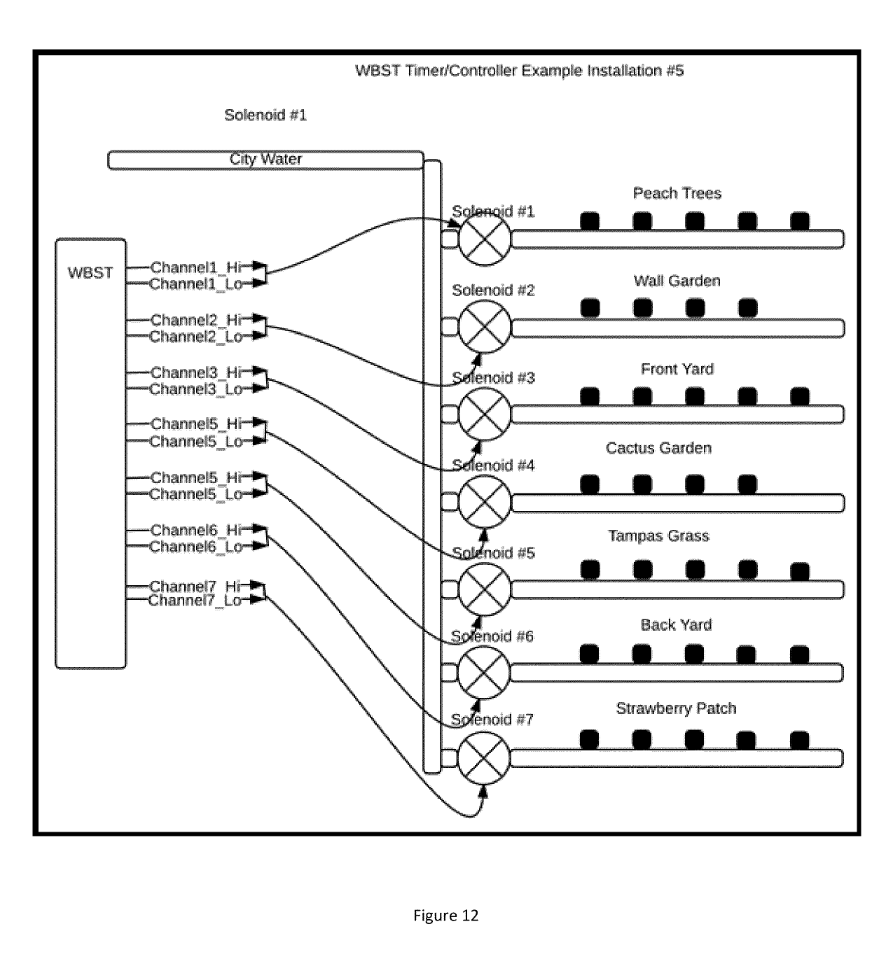

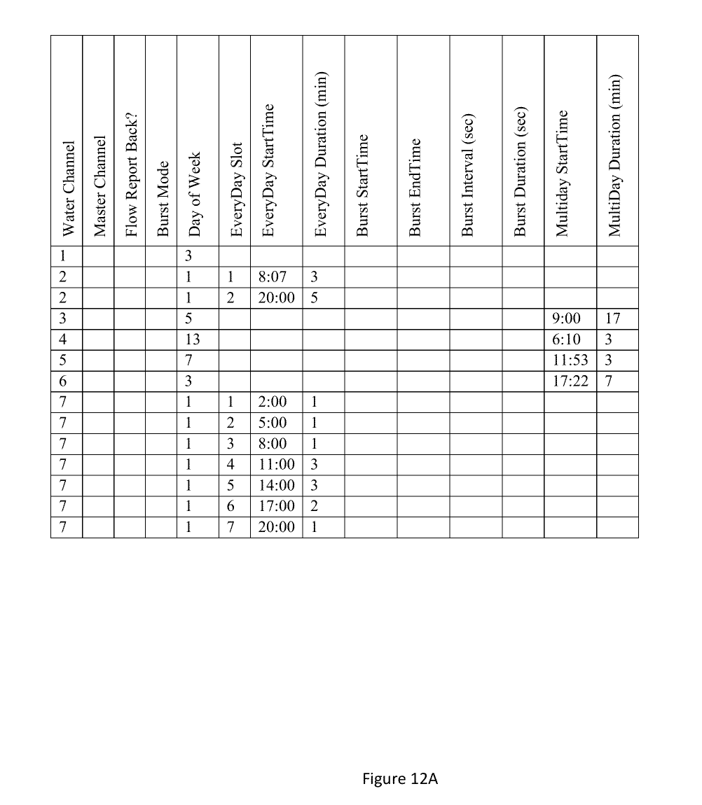

FIG. 12. WBST Timer/Controller Example Installation #5

FIG. 12A. WBST Timer/Controller Data Set up for Installation #5

For a more detailed explanation, refer to the discussion after FIG. 8A, as that discussion generally applies here.

Our irrigation controller has a rich variety of possible watering controls, Since our irrigation controller is configured from the Sypmle application server, we can make it easy for a user to set up complicated arrangements such as up to 8 waterings per water channel per day, or the “burst mode” involving short duration cycles on several watering channels. Also, waterings can be set up for once every two days, once every three days, up to and including once every seven days. Seven day timings can be done on specific days of the week, Sunday, Monday . . . Saturday. Another interesting timing that can be done from messaging from the application server is skipping watering for all or some watering channels for a day. This will happen automatically if our application server discovers that the user's locale will have heavy rains. But the user could also message to the application server to skip the timings on this front lawn for a Saturday because his daughter is going to have a birthday party there.

It is easy for a new user to revert to his original timer/controller. It is expected that most users will be able to successfully make the change to our irrigation controller. But since valuable, established lawns, shrubbery and gardens are involved, we will provide a product called the Loopback Board to make it easy for the user to go back to his original timer/controller. To replace a user's existing controller, his existing 24Vac solenoid wires (one pair for each solenoid) are removed from his timer/controller (usually screw terminals). They are then pressed into our 16-socket wire-mount connector (On-Shore Technologies OSTHW16B050). That connector then snaps into the mating connector on our irrigation controller. However, we supply the user with a small board we call the Loopback Board with another mating connector and 16 pigtail wires. Refer to FIG. 6 above. The user connects the 16 pigtail wires back to his original controller. This way, the user can disconnect from our irrigation controller and insert his wire-mount connector, with all his solenoid wires, into the Loopback Board. His original timer/controller is then back in service. This takes less than ten seconds and requires no special skills. So if a user decides he/she is uncomfortable with the newer technologies in our irrigation controller then the user can switch back to his/her original timer/controller without disrupting or endangering his plantings.

Our irrigation controller detects open solenoids. Since our irrigation controller has a microprocessor, it can sense the electrical current into the solenoids. This can be used to determine if each solenoid, when voltage is applied, is actually being energized. If not, we can report back a status to the application so that the user—or his maintenance vendor—can be contacted to check this particular solenoid.

Our irrigation controller can use optional water flow meters and our FlowCheck board for feedback of water flow. The user has an option of installing one or more water flow meters in his/her irrigation pipes. This is shown in FIGS. 8 through 11. The water flow meter is expected to be an impeller that rotates at a predicable RPM depending on the mass flow rate. The sensing is expected to be magnetic pickup. There can be a small local circuit board unit, the FlowCheck board, which captures this information and sends it back to our irrigation controller, which can then forward the information onto our application server. Refer to FIG. 7. We can power the FlowCheck board using an existing solenoid wire pair. By putting, say, 10Vac on these wire pairs, the FlowCheck board is continuously powered but the solenoid is not actuated due to the low voltage. The FlowCheck board can still remain powered when the 24Vac is applied and the ‘piggybacked” solenoid is energized and water is flowing. So the FlowCheck board can report on slow water leaks when the solenoid is off. And the FlowCheck board can also report water flow when the solenoid is energized. Some wireless arrangement could be done to send the flow information back to the irrigation controller or directly to the application server. However, we thought it is easier and more economical to PLM (power line modulate) on the same “piggybacked” solenoid wire pairs with a digital code. Such technology is often used in home 110Vac wiring to send information. For advanced users, the FlowCheck can be calibrated more accurately than the nominal volume-per-spin specification by using a pipe stub to fill a given volume of water (like a 5 gallon bucket or a 33 gallon trashcan) and the application server can be updated with the calibrated volume-per-spin for this particular water flow meter.

The FlowCheck board can also include sensor power and report back for a variety of sensors including: ground moisture sensor, air humidity sensor, wind gauge, rain gauge, temperature sensor and water head pressure sensor.

The user can easily do software upgrades to his/her irrigation controller firmware. The application server can check the firmware itself for a revision number and upgrade the firmware when a newer firmware download is approved for release. Such an upgrade would require a specific user permission if a general permission has not already been granted. Further, the user can download a firmware file to a USB flashdrive and manually upgrade the firmware. No special skills are required in either case.

The irrigation controller and application server work together to make a robust WiFi-enabled product. There is no access-point hardware needed for the connection. The irrigation controller is web-enabled directly. In one implementation, our irrigation controller connects to the WiFi bi-directional communications network internet by using a device such as an RN-131 designed by Roving Networks. This module will allow the device to connect to the user's infrastructure IEEE 802.11b/g network on all Wi-Fi security protocols (WEP, WPA/WPA2-PSK), and support TCP, UDP, ICMP, DHCP, ARP, IGMP, DNS, HTTP client, and FTP client protocols, and also allow for Ad-hoc as well as infrastructure set ups. In addition to the module's ability to download firmware via FTP, this module can get and put files to an FTP server which, once configured to associate with the user's wireless bi-directional communication network, will be defaulted to connect to Symple's application FTP server. This will be done by using a pre-configured FTP address, directory, and a variable and manipulatable user-name and password (which will be set up in duality with Symple's FTP user management module). When an individual device is in a user's possession, they will be able to set up the device's initial wireless network parameters by using the module's provided software. This software will require the user to set their WLAN SSID, Network type, network's relational password, and any other credentials required to connect a device to their wireless network. The software will then sanitize and check whether the entered data can resolve a connection to the internet by sending a ping request to several websites, including Symple.com. Once connected, the module will then relate the device to the WAP and grant the Symple device a unique IP address. The following diagram illustrates how the device is connected on an infrastructure and ad-hoc network:

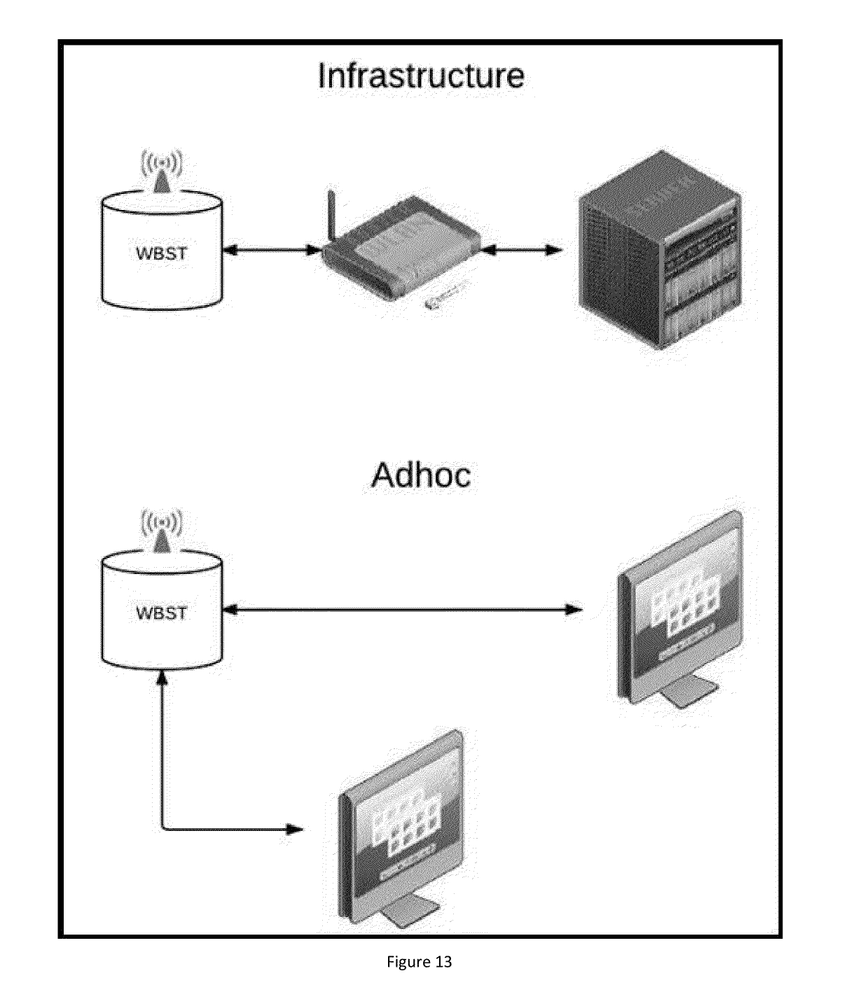

### [FIG. 13]

The irrigation controller can interact with the Symple application server daily or even many times per day as needed. The application server will allow users to install, read back and manipulate the baseline schedule settings manually. All programming data will be sent through the internet. However, if a user does not have internet access, apps will be provided to allow manual ad-hoc networking control. After receiving the information, via an FTP server request by the RN-131 from the internet, it will assess and assign the best watering times and the most efficient quantities of water. The application server will connect to the irrigation controller as necessary, even numerous times per day in order to supply the best weather information available prior to watering for that day. If for any reason a connection cannot be made to the irrigation controller the user can be contacted to correct the situation. Alternatively if the irrigation controller tries to contact the application, but cannot, the irrigation controller will display a message on its LCD or OLED screen. The watering for the day will be set to a default setting allowing the water to flow despite the lack of internet connection and updated weather information.

The irrigation controller is designed for easy installation and easy firmware upgrades. The irrigation controller is roughly 5″ by 8″ by 2″ thick. It is normally installed on a wall in an appropriate area outside of direct sunlight. An internal garage wall is the preferred choice. If not, a shady exterior wall is also good. The protective covering of the components will be plastic. It can survive gentle rainfalls and should be at least 3 feet off the ground. Installation method will require either plastic wall anchors into masonry or high qualities glues in order to hold fast to the surface in a vertical nature. Wires will come out the bottom in an open web. The unit allows finger access for USB insertion and up to 3 buttons. To aid in replacing an existing sprinkler controller we provide a second board, called the LoopBack board, to easily switch back to original timer/controller. All existing solenoid wires will be installed with wire nuts since existing sprinkler installations can have any AWG wire gauge. (We have seen anything from 12AWG to 24AWG.) The irrigation controller will turn on the solenoid with 24Vac at approximately 0.3 amps with a 0.6 amps peak and can provide enough power to enable two solenoids at any one time. This is to support irrigation constructs that have master channels ahead of several downstream channels. Master channel situations are shown in FIGS. 8 and 10.

Refer to FIG. 5 for a view of the irrigation controller hardware block diagram. The hardware components include: LCD display with 16×2 character readout with LCD illumination for reading at night. The WiFi interface is provided by Roving Networks RN-131 or RN-171 (lower power) with antenna. Alternate WiFi interface sources are Texas Instruments C3300 or Microchip MC78M05CDTX. The WiFi interface is about 50% of the board component cost. Microprocessor is from the Microchip PIC24 family. 24Vac is provided by 110Vac primary transformer with 0.8 Amp 24Vac secondary. Another secondary winding provides 0.18 amp of 10Vac to be rectified and converted to 3.3V logic supply and 5.0V USB flash driver power supply. A full wave bridge rectifier with 100 uF capacitor converts the 10Vac into approximately 13Vdc power. Series regulators are then used to convert to the 3.3Vdc and 5.0Vdc—although more expensive switching regulators could be used with slight power savings. The ac power cord is 2-wire and fused to UL rating. For PLM (power line modulation) flow metering, the 24Vac is switched to 10Vac when the channels are not in use. Solenoids are powered by first turning on solid-state relay (SSR) to allow 24Vac then each channel is turned on by thyristor. This saves a lot of money when controlling 16 channels. SSR is needed to turn off the thyristors at the end of a watering cycle, because the thyristors need ac power removed in order to turn off. A separate PCB, called the FlowCheck board, at the flow meter may be required for the PLM water metering. Uses the nearest solenoid's 2 wires both for power and to send back the PLM data. A type-A USB connector allows USB 2.0 or lower flash drive to bootload revised firmware into our controller, allowing users to do their own upgrades. Alternatively, firmware upgrades can be provided from the application server. Our irrigation controller PCB board has hardware revision encoded so that our website can find out the hardware revision and the firmware revision for any user.

### Message Protocol

A full understanding of our controller software is provided in our Message Protocol document. Briefly, the Message Protocol describes the ASCII character exchange between application server and client (our irrigation controller) to set up the baseline schedule, including all the start times, watering duration times, watering days, water flow and sensor assignment input and reportings, master channel assignments, FlowCheck channel assignments, board hardware and software revisions, electrical fault detection, seasonal timing adjustment, skipped or advanced watering days, and security. In addition to the read and write of the baseline schedule, short messages provide a way for the application server to adjust the schedule for one day.

### Enumerated Functions

(1) Each watering channel can be controlled for: (a) up to eight watering times per day (b) multi-day timings for one watering every 2, 3, 4, 5, 6 or 7 days (c) multi-day timings for one watering on Sunday, Monday, Tuesday, Wednesday, Thursday, Friday or Saturday. (2) The channels doing everyday timings can be put into a 9th timing of “burst mode” which turns on channels for a few seconds, waits a few seconds or minutes and repeats this cycle for hours at a time. More than one channel can be put into “burst mode”. This feature is meant for newly seeded lawns in the daylight hours. (3) Several channels can send back digital data to the controller as to the measured flow of the water and other kinds of sensor input. (a) This flow reporting can be calibrated by the user by the simple method or, for most users, use the factory settings. (b) The historical flow data is stored on the application server and can be read by the user over the web in terms of total gallons used—and converted to dollars used by the website. The flow meter feedback can meter the water usage on more than one watering circuit provided the flow meter is placed upstream of each of these circuits on a common feeder pipe. (c) the FlowCheck boards get power from and send back data on a solenoid wire pair using PLM modulation. (4) At any time the irrigation controller can receive a message over WiFi (either ad-hoc network or more likely home-based WiFi bi-directional communications network—infrastructure network). This message can adjust water timings or skip or advance a watering time by one day. The messages can be for adjustments due to expected rainfall, unusual temperature or winds, plant life-cycle needs or other circumstances. (5) Our application servers interpret incoming weather data for the user's zipcode or other locating data and decide on the best method to adjust a given controller's timings. (6) The controller sends back status information to our application server with weekly or monthly summaries of water usages. (7) In addition to allowing a user to program specific timings arrangements, our website can do a plant-based timing where the user puts in the types of lawn grass or vegetable garden plant mixes and the optimal waterings for his locations are automatically done. For example, lettuce gardens need more water than potato gardens. Further, the user will be prompted or messaged with reminders to plant his gardens at the correct times of the year for his needs. (8) The user can elect to follow a local amateur master gardener as to planting times, fertilizer times, and so forth and even photos of the master gardener's garden—all provided through our application server. (9) The user can set up his one seasonal adjustment or select a suggested one for his area for increasing timings as the seasons progress into summer and recede into winter. These adjustments will occur on a daily basis without need for application server intervention (10) Users will be able to easily update the controller's firmware by merely downloading a new version from our application server directly or by placing it on a USB flash drive and inserting the flash drive into the controller. (11) security protection will be provided above and beyond the user's infrastructure networks; WPA or WPA2 encryption. This is especially important if the user does not have his/her own infrastructure network, or is sharing one with a neighbor or is using an ad-hoc network. (13) The application server has by far the most engineering time devoted to it.

(a) it logs in users and maintains security (b) provides a user with manual, plant-specific or master gardener ways to first set up his/her baseline schedule—along with irrigation user-specific names and arrangements (c) data-mines for local weather conditions and communicates with the entire connected set of irrigation controllers to adjust timing for that day (d) also adjusts timings based on plant life-cycles (e) data-mines for agronomy information for specific plant types by location (f) data-mines for historical weather data by location (g) accepts master gardener inputs and blogging for nearby users that follow (h) checks for needed firmware revisions and works with the user to provide them (i) aggregates irrigation waterflow feedback and prepares data for user review (j) analyzes waterflow feedback, electrical fault feedback or other sensor feedback to contact users or maintenance workers. This process is detailed in the following flow chart:

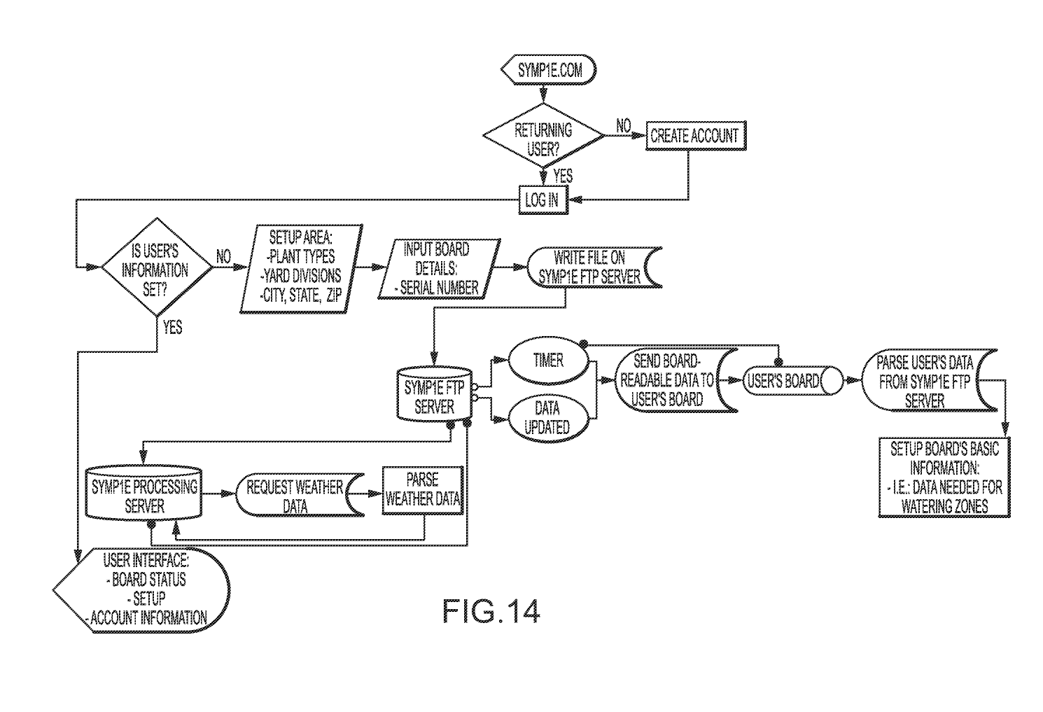

### [FIG. 14]

(12) the user communicates with the application server over a web-enabled appliance that does not need any specific software configuration (13) the irrigation controller communicates with the application server directly, without need of an access point (14) rather than do a complex calculation for optimal watering for a mature lawn, the user can set up a generous timing and the baseline schedule and enable the “backoff mode” that will back off a proscribed amount each week (say 5%) until the user decides the lawn is getting too little water—and rejects the last reduction.

What we claim is:

1. An irrigation control system, comprising:
an irrigation controller to control an irrigation system, where the irrigation controller is configured to communicate directly to a local bi-directional communication network such as a hub, switch or router, without the use of an access point.
an application server which contains information that can be read by the user, using any type of and any number of web-enabled appliances without the use of an access point;
an application server that collects weather, geographic, geologic, agronomy, plant growth data via data-mining from multiple publically accessible servers. If a given server or servers are not accessible at a given moment, the application server merely accesses from a plethora of others.
an application server that stores and maintains weather, geographic, geologic, agronomy, plant growth data.
wherein the irrigation controller is configured with a baseline schedule for controlling the irrigation system. The baseline schedule is computed by direct user control of timings or by application server suggested timings. The baseline schedule can further automatically adjust as the weather seasons progress in his geographic area.
wherein the irrigation controller maintains historical information as to water usage, or power usage and can forward that information up to the application server.
wherein no personal computer or other web-based appliance need to have any configuration to obtain or return information to the application server via the bi-directional communications network without the use of an access point.
wherein the application server is configured to retain a user's baseline schedule and obtain a user's historical water usage or power usage from the irrigation controller via the bi-directional communications network without the use of an access point.
wherein the application server modifies the baseline schedule, using the weather information and then directly provides modifications to the baseline schedule. These modifications occur with or without user-direct manipulation. Water duration times can be increased or decreased or alternatively, watering days can be skipped or advanced.
wherein the application server can load the baseline schedule with local seasonal adjustment to slowly change water timings or days as the seasons progress. In this manner, the irrigation controller can daily adjust for seasonal progressions without need of interaction with the application server.
wherein the application server can also modify the baseline schedule based on specified types of plants or grasses, input from local master gardeners in communication, historical geographic-specific weather information, user drainage and terrain selections.
wherein any number of and any type of web-enabled appliances can control the irrigation controller through the application server from any reasonable web connection (ie not through certain proxy servers).
wherein the irrigation controller has any number of separately-controlled channels to provide the user's irrigation needs.
Wherein the irrigation controller can get sensor data from the irrigation site and revise the baseline schedule with or without sending the information to the application server.

2. The irrigation control system of claim 1, wherein the irrigation timings are based on local plant agronomy databases which control timings based on the life-cycle of specific plants from seeds to seedlings to young plants to mature plants to end of useful life. Changes to the baseline schedule due to these life-cycle requirements are done either at the irrigation controller itself as part of the baseline schedule, or is done by application server adjustments to the baseline schedule as the days proceed. The local plant agronomy databases could be obtained from agricultural experts or even from local amateur master gardeners that the user could choose to follow. A user can follow the local amateur master gardener's blog on the application server including comments and even photographs of his garden in recent days.

3. The irrigation control system of claim 1, wherein there is a special watering mode for starting new lawns, called “burst mode”, although it could also be called “bird scare mode.” The user can select one or more of his watering channels to start a daily cycle that begins at a certain time of day and ends at a chosen time later in the day. The first channel starts off with its burst, for maybe 10 seconds to 60 seconds. Then there is a wait period, maybe 1 minute to 3 minutes, and a second channel can start. The second channel does its small burst and waits another proscribed time and hands off to the first channel or perhaps a third channel. In this way, birds are discouraged to remain on the lawn, eating the newly laid seeds.

4. The irrigation control system of claim 1, wherein there is a special watering conservation search method for mature lawns, called “backoff mode.” Rather than trying to optimize lawn watering based on historical weather data and soil types and soil topology, the user merely starts off with some generous water timings. The timings are reduced in proscribed manner each week (i.e. 5% each week) and the user is messaged to accept or reject the results of this latest water reduction. The user can walk around and observe his lawn, poke into the lawn to get a feel for the watering effectiveness or do whatever he thinks is the best way to assess his watering. After a few weeks, there will be a point where the watering is simply not enough. The user rejects the last attempt at reducing water timings and his lawn watering is now optimal. Of course, as the seasons progress, the lawn waterings are always scaled per the baseline schedule. At some point, a user may decide to enter the “backoff mode” again to optimize his lawn watering to readjust his watering seasonal factors.

5. The irrigation control system of claim 1, wherein the irrigation controller is associated with a user account maintained by the application server. The irrigation controller uses built-in capability to access a user's account maintained by the application servers without the use of an access point. A user sets up the account by communicating with the application server using any number of and any type of web-based appliances without the use of an access point.

6. The irrigation control system of claim 2, wherein the application server maintains information associated with the user account and the user's web-based appliance does not need configuration to access information from and send information to the application server.

7. The irrigation control system of claim 3 wherein:
the application server obtains the current irrigation schedule from the irrigation controller via the bi-directional communication network without the use of an access point.
the user can view the current irrigation schedule stored in the application server and modify it to make a new baseline schedule by use of any number of and any type of web-based appliances without need of configuration that communicates over bi-directional communication network to the application server without the use of an access point.
the irrigation controller retrieves the baseline schedule from the application server and provides the current irrigation schedule (modified baseline schedule) to the application server. These transactions take place via the bi-directional communication network without the use of an access point.
the application server is configured to provide adjustments to the current schedule in the irrigation controller, at any time, with or without user prompting. These transactions take place via the bi-directional communication network without the use of an access point.

8. The irrigation control system of claim 2, further comprising:
one or more separate irrigation controllers communicating with the application server under a single user account. Each irrigation controller has a unique user-provided identification code. Communication transactions include all bi-directional communications of a single irrigation controller system and the application server keeps the information subdivided per irrigation controller. The application server can then aggregate the information per the instructions of the user controlling the user account. These transactions take place via the bi-directional communication network without the use of an access point.
one or more separate irrigation controllers communicating with the application server under different user accounts, operating on the same irrigation site. Each irrigation controller has a unique user-provided identification code. Communication transactions include all bi-directional communications of a single irrigation controller system and the application server keeps the information subdivided per irrigation controller. The application server can then aggregate the information per the instructions of the user controlling all the user accounts. These transactions take place via the bi-directional communication network without the use of an access point.

9. The irrigation control system of claim 2, further comprising:
one or more separate irrigation controllers communicating with the application server under a single user account. Yet the irrigation controllers reach the application server through different hubs, switches or routers. This might need to be done in an application where the physical size of the irrigation site exceeds the range of a normal router. Each irrigation controller has a unique user-provided identification code. Communication transactions include all bi-directional communications of a single irrigation controller system and the application server keeps the information subdivided per irrigation controller. The application server can then aggregate the information per the instructions of the user controlling the user account. These transactions take place via the bi-directional communication network without the use of an access point.
one or more separate irrigation controllers communicating with the application server under different user accounts, operating on the same irrigation site. Yet the irrigation controllers reach the application servers through different routers. This might need to be done in an application where the physical size of the irrigation site exceeds the range of a normal router. Each irrigation controller has a unique user-provided identification code. Communication transactions include all bi-directional communications of a single irrigation controller system and the application server keeps the information subdivided per irrigation controller. The application server can then aggregate the information per the instructions of the user controlling all the user accounts. These transactions take place via the bi-directional communication network without the use of an access point.

10. The irrigation control system of claims 8 and 9, wherein the application server is set up by the user to assign control of individual irrigation controllers to a group of sub-users with their own identification and passwords. Sub-users work only on their portion of the irrigation system, with only the user able to override. The user can set up the application server to restrict certain sub-users to certain scheduling and to aggregate reports of water or power usages in any way the user desires.

11. The irrigation control system of claim 2, wherein:
each user account includes associated contact information for communication modes (ie email address, cell phone number, land-line phone number, twitter account); and
the application server can be configured to contact the user and/or his assigned maintenance workers through any or all modes with warnings or alerts as to problems detected with the user's irrigation system. Such problems could be, but not limited to: excessive or scanty water flow in certain irrigation channels, no electrical current when the solenoid is actuated indicating a solenoid or wiring fault, water usage or power usage exceeding limits, or communication problems with certain irrigation controllers.
The application server can be configured to contact the user and/or his assigned workers though any or all modes as to plant tending actions such as but not limited to: fertilizer application, insecticide application, cultivating, seed or seedling planting times.

12. The irrigation control system of claim 1, wherein:
the application server limits the user's choice of watering times or days or overall watering usage due to local legal requirements, or any controlling legal authority such as home-owner associations. Such requirements may not be known to the user as the system is set up, but is learned by the application server from knowledgeable users or data-mining. The application server finds the legal requirements by using the user's irrigation site location information to find the various controlling legal authorities with jurisdiction over this site.

13. The irrigation control system of claim 12, wherein:
the application server messages the irrigation controller with changes to the schedule based on local weather information while also meeting the local legal requirements.

14. The irrigation control system of claim 1, further comprising at least one sensor configured to communicate sensor information to the irrigation controller. The integration controller provides power and a communication link to the sensors; and
the irrigation controller can modify the irrigation schedule based on information from the sensors.
the irrigation controller can summarize and report the sensor information to the application server using the bi-directional communications network without an access point, which can then store and aggregate the information or message changes to the baseline schedule back to the irrigation controller.

15. The irrigation control system of claim 14, wherein at least one of the sensors is a ground moisture sensor.

16. The irrigation control system of claim 14, wherein at least one of the sensors is a water flow sensor.

17. The irrigation control system of claim 14, wherein at least one of the sensors is an air humidity sensor.

18. The irrigation control system of claim 14, wherein at least one of the sensors is a wind gauge.

19. The irrigation control system of claim 14, wherein at least one of the sensors is a rain gauge.

20. The irrigation control system of claim 14, wherein at least one of the sensors is a temperature sensor.

21. The irrigation control system of claim 14, wherein at least one of the sensors is a water head pressure sensor

22. The irrigation control system of claim 14, wherein the power and communications to the various sensors is done through a pair of solenoid power wires. This wire pair is typically energized to 24Vac to enable one solenoid on one channel controlled from the integration controller. A remote circuit board can be attached to one or more sensors, and have circuitry to power the sensors, get information from the sensors and relay that information back to the integration controller by impressing data signals on the solenoid power wires. Further, the remote circuit board gets its power from the solenoid power wires when solenoid power is provided or even when solenoid power is only fractionally provided (ie ½ or ¼ of the voltage needed to actuate a solenoid). The data modulation on the power wires is similar to PLM (power line modulation) used in homes on 110Vac power wires.

23. The irrigation control system of claim 1, wherein the application server is configured to graphically display water savings achieved by modifications to the baseline irrigation sensor on any number of and any kind of web-enabled appliances. Such graphical displays may have to be tailored based on the kind of web-enabled appliance the user is using. Further, any kind of aggregate data held by the application server can be displayed in graphical or tabular form on the user's web-enabled appliance upon request of the user per choices made available by the application server.

24. The irrigation control system of claim 1, wherein:
The irrigation controller includes an erasable non-volatile memory containing firmware;
the application server is configured to distribute new firmware for the irrigation controller over bi-directional communications network without an access point.
the irrigation controller is configured to load the new firmware into the erasable non-volatile memory.
the new firmware can also be provided by USB device, Bluetooth device or other commonly used communications protocols in addition to the bi-directional communications network without an access point. Such communication protocols include but are not limited to ZigBee, WiFi, LAN, Thunderbolt and Firewire.
the new firmware can also be provided by USB flashdrive.

25. An irrigation system, comprising:
an irrigation controller which controls multiple valves and sensors providing irrigation to various parts of the irrigation site at separate times, where the irrigation controller is configured to communicate to the application server over a local bi-directional network without an access point.
multiple irrigation controllers, each of which controls multiple valves and sensors providing irrigation to various parts of the irrigation site at separate times, wherein multiple irrigation controllers act independently as to irrigation times, where the irrigation controller is configured to communicate to the application server over one or more local bi-directional networks without access points.
wherein the irrigation controllers are configured with a baseline irrigation schedule for controlling the irrigation system;
wherein the irrigation controller is configured to maintain information concerning water usage and power usage;
wherein the application server data-mines a variety of web-sites for geographic location-specific weather information and modifies the irrigation controller's schedule based on that information with or without intervention from the user and using only local bi-directional networks without the need for access points.
wherein the irrigation controllers provide sensor information back to the application server for storage, aggregation, display to user and modification to the irrigation controllers schedule with or without intervention from the user and using only local bi-directional networks without the need for access points.
wherein the irrigation controllers provide sensor information back to the application server and that information can result in messaging or communicating directly to the user or assigned maintenance workers as to problems with the irrigation system.
wherein the user can access the application server to modify the baseline schedule or read-back information from the application server using any number of and any type of web-based appliances, including but not limited to: iPhone, iPad, Droid, Blackberry, Microsoft personal computer, Apple personal computer, from any point in the world with normal web access.

26. The irrigation control system comprising:
an irrigation controller connected to a communication network via a hub, switch or router without the need of an access point;
an irrigation controller configured to control an irrigation system, where the irrigation controller is configured to communicate directly with a local bi-directional communications network without an access point.
an application server configured to communicate over the entire world-wide collection of users that have irrigation controllers or significant portions of the collection, as long as the users conform to the application server information protocols and licensing agreements.
an application server that stores and maintains the entire world-wide collection of user scheduling data, historical water usage and power usage data, all known local legal limits for water usage, all known local weather information, localized plant and grasses growing information. This information can be obtained by application server data-mining or provided by local experts or the user.
An application server that communicates and interacts with users over any number of and any kind of web-enabled appliances, tailoring the display of the graphical or tabular data to the specific kind of web-enabled appliances.

27. The irrigation control system of claim 1, wherein:
the application server can be directed by the user to only temporarily store historical information as to water usage, or power usage, or only temporarily store the irrigation schedule.

28. For a lower-cost irrigation controller that is not web-enabled—or in fact any general purpose timer/controller, start times and duration coding can be done by inserting a programmed USB flash memory.

29. An irrigation control system, comprising:
an irrigation controller to control an irrigation system, where the irrigation controller is configured to communicate directly to a personal computer using ad-hoc protocol without web-access. The ad-hoc protocol accesses a data form located in erasable non-volatile memory on the irrigation controller itself. That data form can be accessed by a browser on the user's web browser. Note that some web-based appliances require special configurations to work with ad-hoc networks; for example, some kinds of Droid smart phones need this. Most of the advantages of the application server (which cannot be reached in this kind of irrigation control system) are available for the user. The user fully controls the baseline schedule. The user can manually collect information from the application server as to seasonal adjustments, local legal watering restrictions or plant-specific life-cycle watering needs.
wherein the irrigation controller is configured with a baseline schedule for controlling the irrigation system. The baseline schedule is computed by direct user control of timings. The baseline schedule can further automatically adjust as the seasons progress in his geographic area.
wherein the irrigation controller maintains historical information as to water usage, or power usage.
wherein no personal computer or other web-based appliance need to have any configuration to obtain or return information to the web-based appliance via the ad-hoc bi-directional communications network without the use of an access point.
wherein the web-based appliance can load the baseline schedule with local seasonal adjustment to slowly change water timings or days as the seasons progress. In this manner, the irrigation controller can daily adjust for seasonal progressions without need of interaction with web-based appliance.
wherein the web-based appliance can also modify the baseline schedule based on specified types of plants or grasses, historical geographic-specific weather information, user drainage and terrain selections.
wherein any number of and any type of web-enabled appliances can control the irrigation controller.
wherein the irrigation controller has any number of separately-controlled channels to provide the user's irrigation needed.
Wherein the irrigation controller can get sensor data from the irrigation site and revise the baseline schedule.

30. A system feature to enable a new user to easily revert to his old irrigation controller, comprising: A Loopback Board with connectorization to enable a user's solenoid wire pairs to be disconnected from our irrigation controller back to his/her original irrigation controller. Such a change can be done in less than ten seconds. This system allows a dissatisfied or unsure user to revert back to his/her original irrigation controller without jeopardizing valuable, established lawns and plantings.
